(19) United States
(12) Patent Application Publication
(10) Pub. No.: US 2026/0313415 A1
(43) Pub. Date: Oct. 8, 2026

(54) METHOD FOR REPORTING MEASUREMENT RESULT, METHOD FOR RECEIVING MEASUREMENT RESULT, COMMUNICATION DEVICE, AND STORAGE MEDIUM

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/996,847

(22) PCT Filed: Jul. 26, 2022
(86) PCT No.: PCT/CN2022/108047

§ 371 Date: Jan. 17, 2025

(51) Int. Cl. H04W 24/10; H04L 5/00; H04W 24/08

(52) U.S. Cl. CPC H04W 24/10; H04L 5/0051; H04W 24/08

(57) ABSTRACT

A method for reporting measurement result, includes: obtaining a measurement result by measuring a signal strength of a CRS; and reporting the measurement result to a network device, where the measurement result is configured to assist the network device in determining a CRS pattern for the terminal to perform rate matching (RM).

### CROSS-REFERENCE TO RELATED APPLICATIONS

The present application is a U.S. National Stage of International Application No. PCT/CN2022/108047, filed on Jul. 26, 2022, the contents of all of which are incorporated herein by reference in their entireties for all purposes.

### BACKGROUND OF THE INVENTION

Currently, in a Dynamic Spectrum Sharing (DSS) scenario, a Long Term Evolution (LTE) system and an NR (New Radio) system may coexist on the same spectrum resource, which may cause interference to the NR system due to some information transmitted by the LTE system.

### SUMMARY OF THE INVENTION

The present disclosure relates to the field of communication technologies, and provides a method for reporting measurement result, a method for receiving measurement result, a device for reporting measurement result, a device for receiving measurement result, a communication device, and a computer-readable storage medium.

According to a first aspect of embodiments of the present disclosure, a method for reporting measurement result is provided, which is performed by a terminal. The method includes: obtaining a measurement result by measuring a signal strength of a CRS; and reporting the measurement result to a network device, where the measurement result is configured to assist the network device in determining a CRS pattern for the terminal to perform rate matching.

According to a second aspect of embodiments of the present disclosure, a method for receiving measurement result is provided, which is performed by a network device. The method includes: receiving a measurement result obtained by measuring a signal strength of a CRS by a terminal, where the measurement result is configured to assist in determining a CRS pattern for the terminal to perform rate matching.

According to a third aspect of embodiments of the present disclosure, a communication device is provided, which includes: one or more processors; and a memory that stores computer programs; where the computer programs, when executed by the one or more processors, causes the one or more processors to:
obtain a measurement result by measuring a signal strength of a cell-specific reference signal (CRS); and
report the measurement result to a network device, wherein the measurement result is configured to assist the network device in determining a CRS pattern for a terminal to perform rate matching.

According to a fourth aspect of embodiments of the present disclosure, a communication device is provided, which includes: one or more processors; and a memory that stores computer programs; where the computer programs, when executed by the one or more processors, causes the one or more processors to implement the method for receiving measurement result.

According to a fifth aspect of embodiments of the present disclosure, a non-transitory computer-readable storage medium that stores one or more computer programs is provided; where the one or more computer programs configured to be executed by one or more processors of a processing device, the one or more programs comprising instructions, when the instructions executed by the processing device, causes the processing device to implement the method for reporting measurement result.

According to a sixth aspect of embodiments of the present disclosure, a non-transitory computer-readable storage medium that stores one or more computer programs is provided; where the one or more computer programs configured to be executed by one or more processors of a processing device, the one or more programs comprising instructions, when the instructions executed by the processing device, causes the processing device to implement the method for receiving measurement result.

### BRIEF DESCRIPTION OF DRAWINGS

To describe the technical solutions in embodiments of the present disclosure more clearly, the following briefly describes the accompanying drawings for describing the embodiments. Apparently, the accompanying drawings in the following description show some embodiments of the present disclosure, and those of ordinary skill in the art may still derive other drawings from these accompanying drawings without creative efforts.

FIG. 1 is a schematic flowchart of a method for reporting measurement result according to an embodiment of the present disclosure.

FIG. 2A is a schematic diagram of a resource range according to an embodiment of the present disclosure.

FIG. 2B is a schematic diagram of a resource range according to another embodiment of the present disclosure.

FIG. 3 is a schematic flowchart of a method for reporting measurement result according to another embodiment of the present disclosure.

FIG. 4 is a schematic flowchart of a method for reporting measurement result according to another embodiment of the present disclosure.

FIG. 5 is a schematic flowchart of a method for reporting measurement result according to another embodiment of the present disclosure.

FIG. 6 is a schematic flowchart of a method for reporting measurement result according to another embodiment of the present disclosure.

FIG. 7 is a schematic flowchart of a method for receiving measurement result according to an embodiment of the present disclosure.

FIG. 8 is a schematic flowchart of a method for receiving measurement result according to another embodiment of the present disclosure.

FIG. 9 is a schematic flowchart of a method for receiving measurement result according to another embodiment of the present disclosure.

FIG. 10 is a schematic block diagram of a device for reporting measurement result according to an embodiment of the present disclosure.

FIG. 11 is a schematic block diagram of a device for receiving measurement result according to an embodiment of the present disclosure.

FIG. 12 is a schematic block diagram of a device for receiving measurement result according to an embodiment of the present disclosure.

FIG. 13 is a schematic block diagram of a device for reporting measurement result according to an embodiment of the present disclosure.

### DETAILED DESCRIPTION OF THE INVENTION

The following clearly and completely describes the technical solutions in embodiments of the present disclosure with reference to the accompanying drawings in embodiments of the present disclosure. Apparently, the described embodiments are merely some but not all of the embodiments of the present disclosure. Based on the embodiments of the present disclosure, all other embodiments obtained by those of ordinary skill in the art without creative efforts fall within the protection scope of the present disclosure.

The terms used in embodiments of the present disclosure are merely for the purpose of illustrating specific embodiments, and are not intended to limit the embodiments of the present disclosure. The terms “a” and “the” of singular forms used in embodiments and the appended claims of the present disclosure are also intended to include plural forms, unless otherwise specified in the context clearly. It can also be understood that the term “and/or” as used herein refers to and includes any and all possible combinations of one or more of the associated listed items.

It can be understood that although the terms first, second, third, and the like may be used in the embodiments of the present disclosure to describe various information. Such information will not be limited by these terms. These terms are merely used to distinguish the same type of information from each other. For example, first information may also be referred to as second information, and similarly, second information may also be referred to as first information, without departing from the scope of the embodiments of the present disclosure. Depending on the context, for example, words “if” used herein may be explained as “while” or “when” or “in response to determining”.

For the purpose of brevity and ease of understanding, the terms “greater than” or “less than”, “higher than” or “lower than” are used herein to characterize a size relationship. However, those skilled in the art may understand that the term “greater than” also includes the meaning of “greater than or equal to”, and “less than” also includes the meaning of “less than or equal to”; the term “higher than” includes the meaning of “higher than or equal to”, and “lower than” also includes the meaning of “lower than or equal to”.

When a Resource Element (RE) corresponding to a cell-specific reference signal (CRS) transmitted by the LTE system conflicts with an RE corresponding to a physical downlink channel in the NR system, interference may occur in a case where a terminal receives a physical downlink channel on the conflicted RE, which reduces the demodulation performance of the physical downlink channel in the NR system.

To solve the above problem to some extent, a method of performing rate matching (RM) according to a CRS pattern may be adopted. For example, when receiving a PDSCH, a terminal may consider the existence of a CRS, and a network device maps the PDSCH to an RE without a CRS. Then, correspondingly, the terminal detects and receives the physical downlink channel on the RE that does not transmit the CRS.

In some cases, for example, when in a junction of a plurality of cells, a terminal is interfered by CRSs transmitted by the plurality of cells, so that rate matching needs to be performed according to CRS patterns of the plurality of cells. However, rate matching according to too many CRS patterns severely limits the capacity of a physical downlink channel and affects the performance and scheduling flexibility of the NR system.

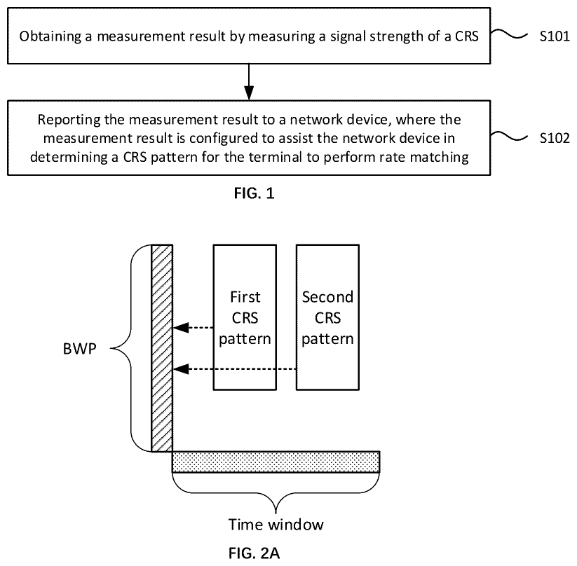

FIG. 1 is a schematic flowchart of a method for reporting measurement result according to an embodiment of the present disclosure. The method for reporting measurement result shown in this embodiment may be performed by a terminal, where the terminal includes, but is not limited to, a mobile phone, a tablet computer, a wearable device, a sensor, an internet of things device, and other communication devices. The terminal may communicate with a network device, where the network device includes, but is not limited to, network devices in 4G, 5G, and 6G communication systems, such as base stations and core networks.

As shown in FIG. 1, the method for reporting measurement result may include the following steps:
step S101, obtaining a measurement result by measuring a signal strength of a CRS; and
step S102, reporting the measurement result to a network device, where the measurement result is configured to assist the network device in determining a CRS pattern for a terminal to perform rate matching.

It is noted that, in all embodiments of the present disclosure, the CRS includes a CRS in an LTE system; and the physical downlink channel includes a physical downlink channel in an NR system, which includes, but is not limited to, a Physical Downlink Shared Channel (PDSCH). Based on the embodiments of the present disclosure, the network device may determine the CRS pattern for the terminal to perform rate matching and instruct the CRS pattern to the terminal, and the terminal may perform rate matching on the PDSCH according to the CRS pattern instructed by the network device.

For a Physical Downlink Control Channel (PDCCH), the network device may perform processing in a puncturing manner according to the CRS pattern. The determination method of the CRS pattern according to which the PDCCH is subjected to puncturing is similar to the determination method of the CRS pattern according to which the PDSCH is subjected to rate matching, that is, the terminal may measure the signal strength of the CRS to obtain a measurement result, and then report the measurement result to the network device, where the measurement result is configured to assist in determining a CRS pattern for puncturing the PDCCH.

In addition, the terminal and the network device in the embodiments of the present disclosure may be co-sited, and may also be non-co-sited.

In an embodiment, the terminal may measure the signal strength of the CRS, where the signal strength includes, but is not limited to, Reference Signal Receiving Power (RSRP) and Signal to Interference plus Noise Ratio (SINR). Further, the terminal may report the measurement result to the network device to assist the network device in determining the CRS pattern for the terminal to perform rate matching (RM).

For example, a physical downlink channel of the terminal is interfered by a plurality of CRS patterns, and the plurality of CRS patterns have different interference degrees, for example, the greater a signal strength of a CRS in an RE corresponding to the CRS pattern, the greater the interference on the NR signal transmission. Therefore, the terminal can report the measurement result obtained by measuring the signal strength of the CRS corresponding to each CRS pattern.

According to the embodiments of the present disclosure, a terminal can measure a signal strength of a CRS and report a measurement result to a network device, such that the network device can determine, according to the measurement result, a CRS pattern with a relatively high degree of interference on a physical downlink channel and then instruct the terminal to perform RM on the CRS pattern with the high degree of interference. Thus, the terminal can only perform RM on the CRS pattern with the relatively high degree of interference and does not have to perform RM on a CRS pattern with a relatively low degree of interference, thereby reducing the number of CRS patterns that need to be subjected to RM, alleviating a limitation on the capacity of a physical downlink channel, and facilitating an improvement in the performance and scheduling flexibility of an NR system.

For example, in response to determining that a physical downlink channel of the terminal is interfered by a first CRS pattern and a second CRS pattern in a corresponding time-frequency domain resource, the terminal may measure a signal strength of a CRS in an RE corresponding to the first CRS pattern to obtain a first measurement result, and measure a signal strength of a CRS in an RE corresponding to the second CRS pattern to obtain a second measurement result.

The terminal may report all the obtained measurement results, for example, report both the first measurement result and the second measurement result to the network device, and the network device may determine which CRS pattern corresponding to the measurement result is a CRS pattern for the terminal to perform the RM. For example, the network device may determine, in the received measurement results, that the CRS pattern corresponding to the measurement result whose signal strength is greater than a strength threshold is a CRS pattern for the terminal needing to perform RM.

The terminal may also analyze the measurement results and then determine a CRS pattern expecting to be subjected to RM, for example, the measurement results may include a mean value of the CRS signal strength in the RE corresponding to the CRS pattern, and then the terminal may determine that the CRS pattern (with relatively strong interference on the physical downlink channel) corresponding to the mean value larger than a mean value threshold is the CRS pattern expecting to be subjected to RM. Further, the terminal reports the measurement result of the CRS pattern expecting to be subjected to RM to the network device, and then the network device may determine, according to the measurement result reported by the terminal, the CRS pattern for the terminal expecting to perform RM as a CRS pattern for terminal to perform RM, and may also determine, according to an actual situation, a CRS pattern for the terminal needing to perform RM.

It is noted that the measurement result may be the measured signal strength of the CRS, or may be CRS pattern related information that is further obtained after measuring the signal strength of the CRS and expects to perform rate matching. For example, the network device may instruct a to-be-measured CRS pattern, and the terminal may measure a signal strength of a CRS in the to-be-measured CRS pattern, may report the measured signal strength as a measurement result, may determine a mean value of a signal strength of a CRS in each to-be-measured CRS pattern, and then determines an identifier of a to-be-measured CRS pattern corresponding to the mean value of the signal strength greater than a strength threshold as a measurement result and report the identifier, where the reported identifier is an identifier of the CRS pattern expecting to be subjected to rate matching.

In an embodiment, the method further includes: determining a CRS pattern needing to be subjected to rate matching according to instruction information transmitted by the network device.

For example, the network device determines, according to the measurement result reported by the terminal, that the first CRS pattern is a CRS pattern for the terminal to perform RM, and may instruct the terminal to perform RM on the first CRS pattern by the instruction information, and when receiving the physical downlink channel, the terminal may consider the existence of a CRS in the first CRS pattern, and map the physical downlink channel to an RE other than the first CRS pattern. Correspondingly, the terminal detects and receives the physical downlink channel on the RE other than the first CRS pattern.

For the second CRS pattern, the terminal does not have to perform RM, then the terminal may not consider the presence of a CRS in the second CRS pattern, and the network device may map the physical downlink channel to an RE corresponding to the second CRS pattern. Correspondingly, the terminal may detect and receive the physical downlink channel on the RE corresponding to the second CRS pattern.

Accordingly, in a case where the terminal is interfered by the first CRS pattern and the second CRS pattern in the physical downlink channel, the network device may determine the first CRS pattern with relatively strong interference as a CRS pattern needing to be subjected to RM, and does not have to instruct the terminal to perform RM for the second CRS pattern with relatively weak interference. Therefore, in response to determining that the physical downlink channel is configured, an RE corresponding to the second CRS pattern does not have to be subjected to RM, so that the capacity of the physical downlink channel is favorably improved, and the performance and the scheduling flexibility of an NR system are improved.

In an embodiment, the terminal may report the measurement result carried by uplink control information (UCI), channel state information (CSI), physical uplink shared channel (PUSCH), and the like to the network device, or may select to report the measurement result carried by other information based on a requirement.

In an embodiment, obtain a measurement result by measuring a signal strength of a CRS includes: measuring the signal strength of the CRS within a predetermined resource range to obtain the measurement result.

The predetermined resource range may be determined according to a protocol agreement, may be instructed by a network device, or may be determined autonomously by a terminal.

For example, in a case where the network device instructs the resource range, the network device may instruct the resource range to the terminal through a signaling, where the network device may determine the resource range according to an actual situation, or may determine the resource range according to a measurement capability reported by the terminal.

In an embodiment, the resource range includes a time domain resource range. Within the time domain resource range, signals other than the CRS are not expected to be received, data transmission is not expected to be performed, and no signals or data may be transmitted to the network device. Correspondingly, the network device does not transmit signals other than the CRS or data to the terminal within the time domain resource range, or may not receive signals or data transmitted by the terminal. Therefore, the measurement of the CRS by the terminal within the time domain resource range is unlikely interfered, and the accurate measurement result is ensured.

In an embodiment, the time domain resource range may be determined according to a predefined rule (for example, a protocol agreement) or may be instructed by the network device.

The determination of the time domain resource range according to the instruction of the network device is taken as an example. For example, the time domain resource range may include a time window, and the terminal may determine the time window according to a start position and a duration instructed by the network device, or may determine the time window according to a start position and an end position instructed by the network device. For example, the time domain resource range may include at least one time domain unit (radio frame, subframe, slot, and symbol), and the terminal may determine the time domain resource range according to a start time domain unit and the number of time domain units instructed by the network device. The time window may be periodic or aperiodic, and may be set specifically based on a requirement.

It is noted that a resource range may include a frequency domain resource range in addition to a time domain resource range, and the frequency domain resource range may include, for example, at least one frequency domain unit (band, component carrier, and bandwidth part).

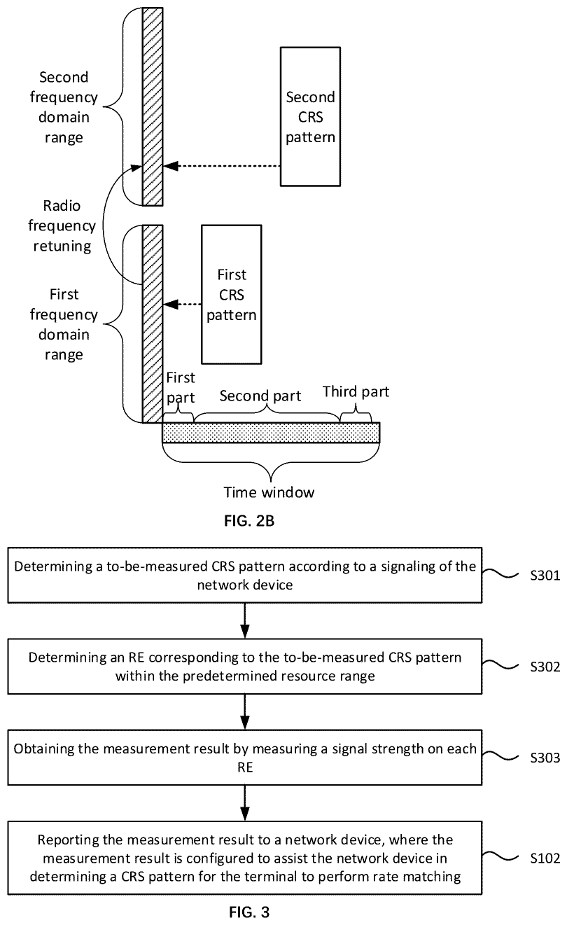

FIG. 2A is a schematic diagram of a resource range according to an embodiment of the present disclosure.

As shown in FIG. 2A, taking a resource range including a time window in a time domain and a bandwidth part (BWP) in a frequency domain, and a physical downlink channel being interfered by a first CRS pattern and a second CRS pattern within the BWP as an example, a terminal may measure RSRP of a CRS in an RE corresponding to the first CRS pattern and RSRP of a CRS in an RE corresponding to the second CRS pattern in the time window and BWP shown in FIG. 2A, and report an obtained measurement result to the network device.

FIG. 2B is a schematic diagram of another resource range according to an embodiment of the present disclosure.

As shown in FIG. 2B, a resource range includes a time window in a time domain and a first frequency domain range (for example, BWP) within a component carrier (CC) in a frequency domain, and the time window may include three parts. In a first part, a terminal is configured to perform radio frequency retuning (RF retuning), for example, retuning the RF to a second frequency domain range. In a second part, a terminal measures a signal strength of a CRS. In a third part, a terminal may perform radio frequency retuning from a second frequency domain range back to the first frequency domain range.

The terminal is interfered by the first CRS pattern within the first frequency domain and the second CRS pattern within the second frequency domain, measures the RSRP of a CRS in an RE corresponding to the second CRS pattern in the second part of the time window shown in FIG. 2B, and reports an obtained measurement result to a network device.

It is noted that, in the time window, a duration for measurement (the second part) and a duration for the radio frequency retuning (the first part and the third part) may be determined according to a predefined rule (for example, a protocol agreement) or may be instructed by a network device.

FIG. 3 is a schematic flowchart of a method for reporting measurement result according to another embodiment of the present disclosure. As shown in FIG. 3, measuring the signal strength of the CRS includes:
step S301, determining a to-be-measured CRS pattern according to a signaling of the network device;
step S302, determining an RE corresponding to the to-be-measured CRS pattern within the predetermined resource range; and
step S303, obtaining the measurement result by measuring a signal strength on each RE.

In an embodiment, a terminal may determine, according to a to-be-measured CRS pattern (which may include one or more CRS patterns) instructed by a network device, that the signal strength of the CRS needs to be measured on an RE corresponding to the to-be-measured CRS pattern, and may measure, within a predetermined resource range, the signal strength on the RE corresponding to the to-be-measured CRS pattern, so as to obtain the measurement result and report the measurement result.

In this embodiment, the terminal may determine, according to the to-be-measured CRS pattern instructed by the network device, that the signal strength of the CRS needs to be measured on the RE corresponding to the to-be-measured CRS pattern, so that REs other than the CRS pattern does not have to be measured in the process of obtaining the measurement result, which is beneficial to simplifying the measurement process and saving the implementation complexity of the terminal.

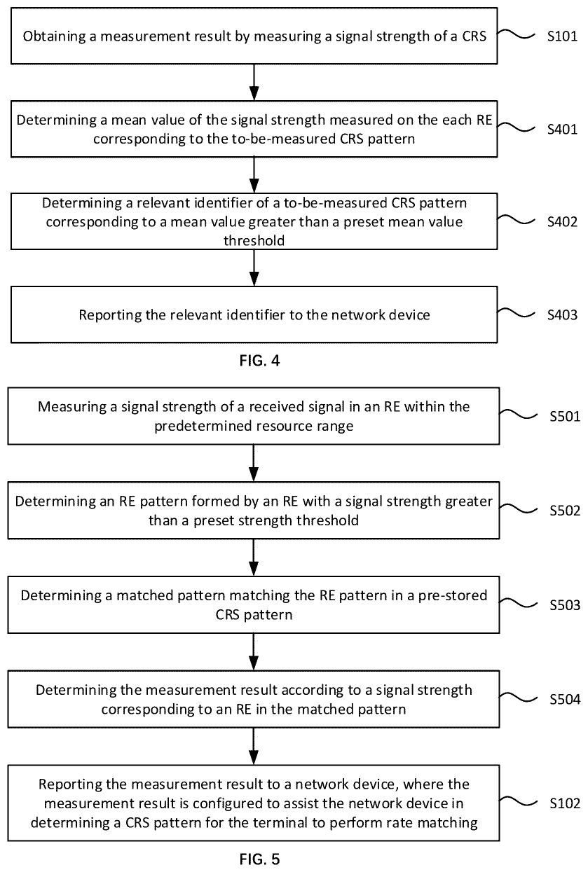

FIG. 4 is a schematic flowchart of a method for reporting measurement result according to another embodiment of the present disclosure. As shown in FIG. 4, reporting the measurement result to the network device includes:
step S401, determining a mean value of the signal strength measured on the each RE corresponding to the to-be-measured CRS pattern;
step S402, determining a relevant identifier of a to-be-measured CRS pattern corresponding to a mean value greater than a preset mean value threshold; and
step S403, reporting the relevant identifier to the network device.

In an embodiment, after measuring the signal strength on the RE corresponding to the to-be-measured CRS pattern, the terminal may further calculate a mean value of the signal strength on the RE, then determine that a to-be-measured CRS pattern corresponding to the mean value greater than a mean value threshold have a relatively high degree of interference on a physical downlink channel, and report the to-be-measured CRS pattern corresponding to the mean value as a CRS pattern expecting to be subjected to RM to the network device.

To save resources occupied by reporting, the reporting content may be simplified, that is, the measurement result or the mean value is not directly reported, but a relevant identifier of the to-be-measured CRS pattern corresponding to the mean value greater than a mean value threshold, such as a serial number of the CRS pattern and an identifier of a cell corresponding to the CRS pattern, is determined, and then the determined relevant identifier is reported to the network device. The network device can determine a CRS pattern for a terminal expecting to perform RM according to the relevant identifier.

FIG. 5 is a schematic flowchart of a method for reporting measurement result according to another embodiment of the present disclosure. As shown in FIG. 5, measuring the signal strength of the CRS includes:
step S501, measuring a signal strength of a received signal in an RE within the predetermined resource range;
step S502, determining an RE pattern formed by an RE with a signal strength greater than a preset strength threshold;
step S503, determining a matched pattern matching the RE pattern in a pre-stored CRS pattern; and
step S504, determining the measurement result according to a signal strength corresponding to an RE in the matched pattern.

In an embodiment, in a case where the network device does not instruct the to-be-measured CRS pattern, the terminal does not know which REs need to be measured and therefore needs to measure the signal strengths of received signals of all REs in a predetermined resource range, and determine the RE with the signal strength greater than the preset strength threshold. Since the signal strengths on this RE are relatively large, this RE are likely to have a CRS.

In addition, for each number of ports (for example, 1 port, 2 ports, and 4 ports), the CRS pattern is fixed, that is, a relationship between REs configured to transmit CRS is fixed. Then the terminal can pre-store the CRS patterns corresponding to each number of ports, construct an RE pattern formed by an RE with CRS, and then match the pre-stored CRS patterns with the RE pattern.

Then, a matched pattern matching the RE pattern in the pre-stored CRS patterns is a CRS pattern that causes interference on the physical downlink channel, that is, a to-be-measured CRS pattern, and thus the measurement result may be determined according to the signal strength corresponding to the RE in the matched pattern.

Therefore, the to-be-measured CRS pattern may be determined in a case where the network device does not instruct the to-be-measured CRS pattern, and further, the measurement result may be determined according to the signal strength corresponding to the RE in the matched pattern and reported to the network device.

For example, a plurality of CRS patterns may be pre-stored, then a matching degree of each pre-stored CRS pattern with the RE pattern determined by the measurement is determined, and the CRS pattern with the matching degree greater than a matching threshold may be used as the matched pattern.

The matching degree may be determined according to the number of overlapping REs, for example, the more the number of overlapping REs in the REs pattern determined by the measurement, the higher the matching degree. The matching degree may also be determined according to the signal strengths of REs corresponding to the pre-stored CRS patterns, for example, for each pre-stored CRS pattern, the mean value of the signal strengths of the REs corresponding to the CRS patterns may be measured, and the larger the mean value of the signal strengths, the higher the matching degree.

It is noted that the matched pattern may be one CRS pattern, or may be a plurality of CRS patterns. In addition, in response to not determining the matched pattern, the terminal may not report the measurement result, or may report the measurement result and add additional information to the measurement result, where the additional information is configured to instruct that the matched pattern is not determined. Then the network device may selectively determine that there is no CRS pattern that requires the terminal to perform RM.

In an embodiment, reporting the measurement result to the network device includes: reporting a feature of the matched pattern to the network device.

In an embodiment, the measurement result of the signal strength corresponding to the RE in the matched pattern may be directly reported to the network device, or the feature of the matched pattern may be determined, and then the feature of the matched pattern is reported to the network device, where the feature of the matched pattern is configured to characterize information of the RE corresponding to the matched pattern, including but not limited to, the number of ports corresponding to the matched pattern.

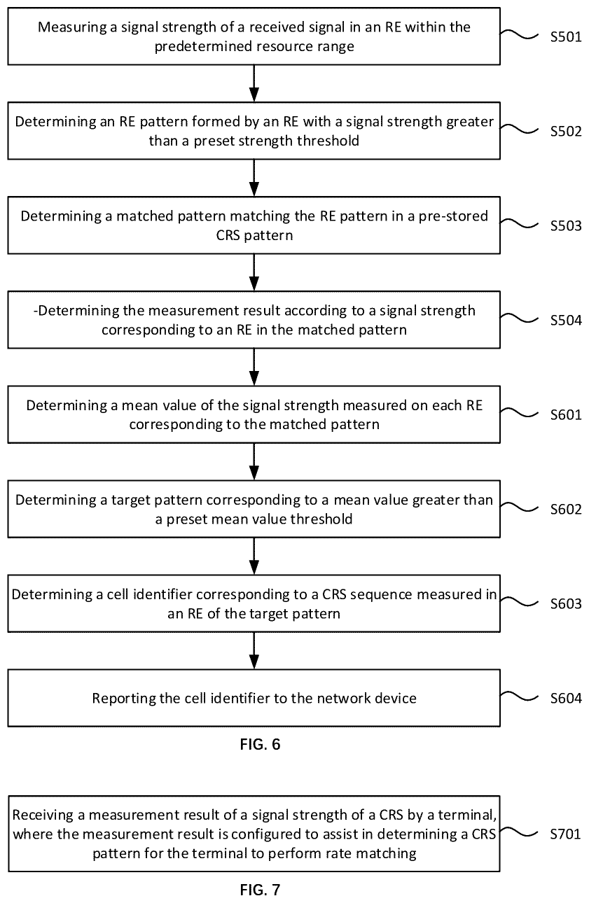

In addition to the method for reporting measurement result, as shown in the following embodiment of FIG. 6, a cell identifier corresponding to the measurement result is determined and reported to the network device, so as to save uplink transmission resources.

FIG. 6 is a schematic flowchart of a method for reporting measurement result according to another embodiment of the present disclosure. As shown in FIG. 6, reporting the measurement result to the network device includes:
step S601, determining a mean value of the signal strength measured on each RE corresponding to the matched pattern;
step S602, determining a target pattern corresponding to a mean value greater than a preset mean value threshold;
step S603, determining a cell identifier corresponding to a CRS sequence measured in an RE of the target pattern; and
step S604, reporting the cell identifier to the network device.

In an embodiment, the measurement result of the signal strength corresponding to the RE in the matched pattern may be directly reported to the network device, or the feature of the matched pattern may be reported. However, the measurement result and the feature generally have a relatively large data amount, and uplink resources occupied by reporting to the network device are large, so that simplification of the reported information may be considered.

The terminal can determine an association relationship between the CRS sequences and the cell identifiers, and accordingly, the terminal can determine the cell identifier corresponding to each CRS sequence. Further, the terminal can calculate a mean value of the signal strength on the RE corresponding to the matched pattern, and then determine that the interference degree of a target pattern corresponding to the mean value greater than a preset mean value threshold to the physical downlink channel is relatively large, so that the target pattern may be used as a CRS pattern expecting to be subjected to RM.

To save resources occupied by reporting, the reporting content may be simplified. For example, a cell identifier corresponding to the CRS sequence may be determined in the association relationship according to the CRS sequence measured in the RE of the target pattern, and then the cell identifier is reported to the network device.

Since the network device stores a corresponding relationship between the cell identifier and the CRS pattern (in this embodiment, the terminal side may not store the corresponding relationship), the network device may determine a CRS pattern for the terminal to perform RM according to the cell identifier reported by the terminal.

FIG. 7 is a schematic flowchart of a method for receiving measurement result according to an embodiment of the present disclosure. The method for receiving measurement result shown in this embodiment may be performed by a network device. The network device may be in communication with a terminal, the network device includes, but is not limited to, a base station in a communication system such as a 4G base station, a 5G base station, and a 6G base station, and the terminal includes, but is not limited to, a mobile phone, a tablet computer, a wearable device, a sensor, an internet of things device, and other communication devices.

As shown in FIG. 7, the method for receiving measurement result may include the following steps:
step S701, receiving a measurement result obtained by measuring a signal strength of a CRS by a terminal, where the measurement result is configured to assist in determining a CRS pattern for the terminal to perform rate matching.

In an embodiment, the terminal may measure the signal strength of the CRS, where the signal strength includes, but is not limited to, RSRP and SINR. Further, the terminal may report the measurement result to the network device to assist the network device in determining the CRS pattern for the terminal to perform rate matching (RM).

For example, a physical downlink channel of the terminal is interfered by a plurality of CRS patterns, and the plurality of CRS patterns have different interference degrees, for example, the greater a signal strength of a CRS in an RE corresponding to the CRS pattern, the greater the interference on the NR signal transmission. Therefore, the terminal can report the measurement result obtained by measuring the signal strength of the CRS corresponding to each CRS pattern.

According to the embodiments of the present disclosure, the network device may determine, according to the measurement result obtained by measuring the signal strength of the CRS by the terminal, a CRS pattern with a relatively high degree of interference on a physical downlink channel and then instruct the terminal to perform RM on the CRS pattern with the high degree of interference. In this way, the terminal can only perform RM on the CRS pattern with the relatively high degree of interference and does not have to perform RM on a CRS pattern with a relatively low degree of interference, thereby reducing the number of CRS patterns that need to be subjected to RM, alleviating a limitation on the capacity of a physical downlink channel, and facilitating an improvement in the performance and scheduling flexibility of an NR system.

For example, in response to determining that a physical downlink channel of the terminal is interfered by a first CRS pattern and a second CRS pattern in a corresponding time-frequency domain resource, the terminal may measure a signal strength of a CRS in an RE corresponding to the first CRS pattern to obtain a first measurement result, and measure a signal strength of a CRS in an RE corresponding to the second CRS pattern to obtain a second measurement result.

The terminal may report all the obtained measurement results, for example, report both the first measurement result and the second measurement result to the network device, and the network device may determine which CRS pattern corresponding to the measurement result is a CRS pattern for the terminal to perform the RM. For example, the network device may determine, in the received measurement results, that the CRS pattern corresponding to the measurement result whose signal strength is greater than a strength threshold is a CRS pattern for the terminal needing to perform RM.

The terminal may also analyze the measurement results and then determine a CRS pattern expecting to be subjected to RM, for example, the measurement results may include a mean value of the CRS signal strength in the RE corresponding to the CRS pattern, and then the terminal may determine that the CRS pattern (with relatively strong interference on the physical downlink channel) corresponding to the mean value larger than a mean value threshold is a CRS pattern expecting to be subjected to RM. Further, the terminal reports the measurement result of the CRS pattern expecting to be subjected to RM to the network device, and then the network device may determine, according to the measurement result reported by the terminal, the CRS pattern for the terminal expecting to perform RM as a CRS pattern for terminal to perform RM, and may also determine, according to an actual situation, a CRS pattern for the terminal needing to perform RM.

It is noted that the measurement result may be the measured signal strength of the CRS, or may be CRS pattern related information that is further obtained after measuring the signal strength of the CRS and expects to perform rate matching. For example, the network device may instruct a to-be-measured CRS pattern, and the terminal may measure a signal strength of a CRS in the to-be-measured CRS pattern, may report the measured signal strength as a measurement result, may determine a mean value of a signal strength of a CRS in each to-be-measured CRS pattern, and then determines an identifier of a to-be-measured CRS pattern corresponding to the mean value of the signal strength greater than a strength threshold as a measurement result and report the identifier, where the reported identifier is an identifier of the CRS pattern expecting to be subjected to rate matching.

In an embodiment, the method further includes: determining a CRS pattern for the terminal to perform rate matching according to the measurement result; and transmitting instruction information to the terminal, where the instruction information is configured to instruct a CRS pattern needing to be subjected to rate matching.

For example, the network device determines, according to the measurement result reported by the terminal, that the first CRS pattern is a CRS pattern for the terminal to perform RM, and may instruct the terminal to perform RM on the first CRS pattern by the instruction information, and when receiving the physical downlink channel, the terminal may consider the existence of a CRS in the first CRS pattern, and map the physical downlink channel to an RE other than the first CRS pattern. Correspondingly, the terminal detects and receives the physical downlink channel on the RE other than the first CRS pattern.

For the second CRS pattern, the terminal does not have to perform RM, then the terminal may not consider the presence of a CRS in the second CRS pattern, and the network device may map the physical downlink channel to an RE corresponding to the second CRS pattern. Correspondingly, the terminal may detect and receive the physical downlink channel on the RE corresponding to the second CRS pattern.

Accordingly, in a case where the terminal is interfered by the first CRS pattern and the second CRS pattern in the physical downlink channel, the network device may determine the first CRS pattern with relatively strong interference as a CRS pattern needing to be subjected to RM, and does not have to instruct the terminal to perform RM for the second CRS pattern with relatively weak interference. Therefore, in response to determining that the physical downlink channel is configured, an RE corresponding to the second CRS pattern does not have to be subjected to RM, so that the capacity of the physical downlink channel is favorably improved, and the performance and the scheduling flexibility of an NR system are improved.

In an embodiment, the network device may obtain the measurement result from the uplink control information (UCI), the channel state information (CSI), the PUSCH, and the like transmitted by the terminal, and certainly, may also obtain the measurement result from other information transmitted by the terminal for reporting.

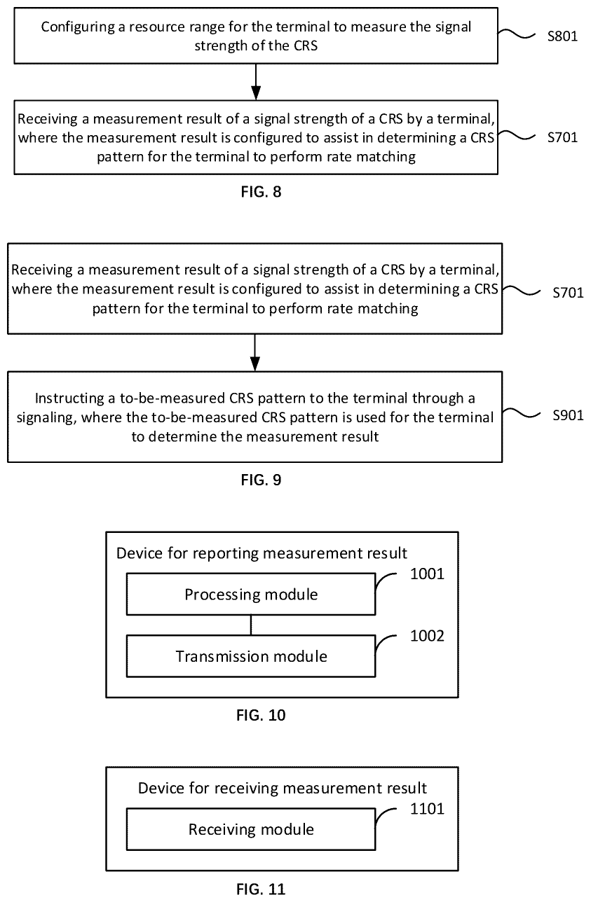

FIG. 8 is a schematic flowchart of a method for receiving measurement result according to another embodiment of the present disclosure. As shown in FIG. 8, the method further includes:
step S801, configuring a resource range for the terminal to measure the signal strength of the CRS.

In an embodiment, the network device may configure, for the terminal, a resource range for measuring the signal strength of the CRS, and the terminal may measure the signal strength of the CRS within a resource range configured by the network device to obtain a measurement result. For example, in a case where the network device instructs the resource range, the network device may instruct the resource range to the terminal through a signaling, where the network device may determine the resource range according to an actual situation, or may determine the resource range according to a measurement capability reported by the terminal.

In an embodiment, the resource range includes a time domain resource range. Within the time domain resource range, signals other than the CRS or data are not transmitted to the terminal, or signals or data transmitted by the terminal may be not received. Correspondingly, within the time domain resource range, signals other than the CRS are not expected to be received, data transmission is not expected to be performed, and no signals or data may be transmitted to the network device. Therefore, the measurement of the CRS by the terminal within the time domain resource range is unlikely interfered, and the accurate measurement result is ensured.

For example, the time domain resource range may include a time window, and the network device may instruct a start position and a duration of the time window to the terminal, and may also instruct a start position and an end position of the time window to the terminal. For example, the time domain resource range may include at least one time domain unit (radio frame, subframe, slot, and symbol), and the network device may instruct a start time domain unit and the number of time domain units of the time domain resource range to the terminal.

It is noted that a resource range may include a frequency domain resource range in addition to a time domain resource range, and the frequency domain resource range may include, for example, at least one frequency domain unit (band, component carrier, and bandwidth part).

FIG. 9 is a schematic flowchart of a method for receiving measurement result according to another embodiment of the present disclosure. As shown in FIG. 9, the method further includes:
step S901, instructing a to-be-measured CRS pattern to the terminal through a signaling, where the to-be-measured CRS pattern is used for the terminal to determine the measurement result.

In an embodiment, the network device may instruct a to-be-measured CRS pattern (which may include one or more CRS patterns) to the terminal through a signaling, and the terminal may determine, according to the to-be-measured CRS pattern instructed by the network device, that the signal strength of the CRS needs to be measured on an RE corresponding to the to-be-measured CRS pattern, and may measure, within a predetermined resource range, the signal strength on the RE corresponding to the to-be-measured CRS pattern, so as to obtain the measurement result and report the measurement result.

In this embodiment, the terminal may determine, according to the to-be-measured CRS pattern instructed by the network device, that the signal strength of the CRS needs to be measured on the RE corresponding to the to-be-measured CRS pattern, so that REs other than the CRS pattern does not have to be measured in the process of obtaining the measurement result, which is beneficial to simplifying the measurement process and saving the battery level of the terminal.

Corresponding to the embodiments of the method for reporting measurement result and the method for receiving measurement result, the present disclosure further provides embodiments of a device for reporting measurement result and a device for receiving measurement result.

FIG. 10 is a schematic block diagram of a device for reporting measurement result according to an embodiment of the present disclosure. The device for reporting measurement result shown in this embodiment may be a terminal, or a device formed by modules in a terminal, where the terminal includes, but is not limited to, a mobile phone, a tablet computer, a wearable device, a sensor, an internet of things device, and other communication devices. The terminal may communicate with a network device, where the network device includes, but is not limited to, network devices in 4G, 5G, and 6G communication systems, such as base stations and core networks.

As shown in FIG. 10, the device for reporting measurement result may include:
a processing module 1001, configured to obtain a measurement result by measuring a signal strength of a CRS; and
a transmission module 1002, configured to report the measurement result to a network device, where the measurement result is configured to assist the network device in determining a CRS pattern for a terminal to perform rate matching.

In an embodiment, the processing module 1001 is configured to obtain the measurement result by measuring the signal strength of the CRS within a predetermined resource range.

In an embodiment, the resource range includes a time domain resource range. Within the time domain resource range, signals other than the CRS are not expected to be received, and data transmission is not expected to be performed.

In an embodiment, the processing module 1001 is configured to determine a to-be-measured CRS pattern according to a signaling of a network device; determine a resource element (RE) corresponding to the to-be-measured CRS pattern within the predetermined resource range; and obtain a measurement result by measuring a signal strength on each RE.

In an embodiment, the processing module 1001 is further configured to determine a mean value of the signal strength measured on the each RE corresponding to the to-be-measured CRS pattern, and determine a relevant identifier of a to-be-measured CRS pattern corresponding to a mean value greater than a preset mean value threshold; where the transmission module 1002 is configured to report the relevant identifier to the network device.

In an embodiment, the processing module 1001 is configured to measure a signal strength of a received signal in an RE within the predetermined resource range; determine an RE pattern formed by an RE with a signal strength greater than a preset strength threshold; determine a matched pattern matching the RE pattern in a pre-stored CRS pattern; and determine the measurement result according to a signal strength corresponding to an RE in the matched pattern.

In an embodiment, the transmission module 1002 is configured to: report a feature of the matched pattern to the network device.

In an embodiment, the processing module 1001 is further configured to determine a mean value of the signal strength measured on each RE corresponding to the matched pattern; determine a target pattern corresponding to a mean value greater than a preset mean value threshold; and determine a cell identifier corresponding to a CRS sequence measured in an RE of the target pattern; where the transmission module 1002 is configured to report the cell identifier to the network device.

In an embodiment, the processing module 1001 is further configured to determine a CRS pattern needing to be subjected to rate matching according to instruction information transmitted by the network device.

FIG. 11 is a schematic block diagram of a device for receiving measurement result according to an embodiment of the present disclosure. The device for receiving measurement result shown in this embodiment may be a network device, or a device formed by modules in the network device, and the network device may communicate with a terminal, where the terminal includes, but is not limited to, a mobile phone, a tablet computer, a wearable device, a sensor, an internet of things device, and other communication devices. The network device includes, but is not limited to, network devices in 4G, 5G, and 6G communication systems, such as base stations and core networks.

As shown in FIG. 11, the device for receiving measurement result may include:
a receiving module 1101, configured to receive a measurement result obtained by measuring a signal strength of a CRS by a terminal, where the measurement result is configured to assist in determining a CRS pattern for the terminal to perform rate matching.

In an embodiment, the device further includes: a transmission module, configured to configure a resource range for the terminal to measure the signal strength of the CRS.

In an embodiment, the resource range includes a time domain resource range. Within the time domain resource range, signals other than the CRS or data are not transmitted to the terminal.

In an embodiment, the device further includes: a transmission module, configured to instruct a to-be-measured CRS pattern to the terminal through a signaling, where the to-be-measured CRS pattern is used for the terminal to determine the measurement result.

In an embodiment, the device further includes: a processing module, configured to determine a CRS pattern for the terminal to perform rate matching according to the measurement result; and a transmission module, configured to transmit instruction information to the terminal, where the instruction information is configured to instruct a CRS pattern needing to be subjected to rate matching.

For the device in the foregoing embodiment, specific manners of performing operations by each module are described in detail in embodiments related to the method, and details are not described herein.

A device embodiment basically corresponds to a method embodiment; and for related parts, reference may be made to partial descriptions in the method embodiment. The described device embodiments are merely examples. The modules described as separate parts may or may not be physically separate, and parts displayed as modules may or may not be physical modules, may be located at one position, or may be distributed on a plurality of network modules. Some or all the modules may be selected according to an actual need to achieve the objectives of the solutions of the embodiments. Those of ordinary skill in the art may understand and implement embodiments of the present disclosure without creative efforts.

An embodiment of the present disclosure further provides a communication device, including: a processor; and a memory that stores computer programs; where the computer programs, when executed by the processor, causes the processor to implement the method for reporting measurement result according to any one of the foregoing embodiments.

An embodiment of the present disclosure further provides a communication device, including: a processor; and a memory that stores computer programs; where the computer programs, when executed by the processor, causes the processor to implement the method for receiving measurement result according to any one of the foregoing embodiments.

An embodiment of the present disclosure further provides a computer-readable storage medium that stores computer programs; where the computer programs, when executed by a processor, causes the processor to implement the method for reporting measurement result according to any one of the foregoing embodiments.

An embodiment of the present disclosure further provides a computer-readable storage medium that stores computer programs; where the computer programs, when executed by a processor, causes the processor to implement the method for receiving measurement result according to any one of the foregoing embodiments.

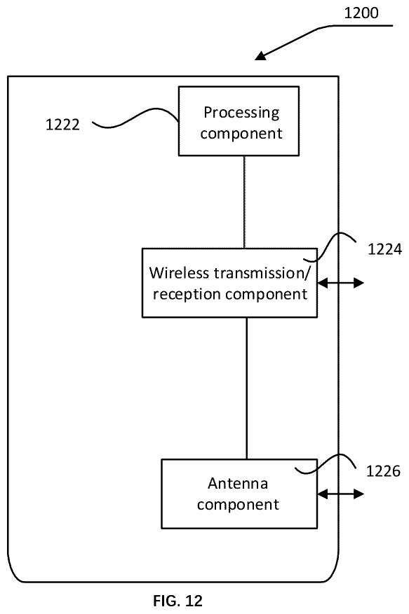

As shown in FIG. 12, FIG. 12 is a schematic block diagram of a device 1200 for receiving measurement result according to an embodiment of the present disclosure. The device 1200 may be provided as a base station. Referring to FIG. 12, the device 1200 includes a processing component 1222, a wireless transmission/reception component 1224, an antenna component 1226, and a signal processing part specific to the wireless interface. The processing component 1222 may further include one or more processors. One of the processors in the processing component 1222 may be configured to implement the method for receiving measurement result according to any one of the foregoing embodiments.

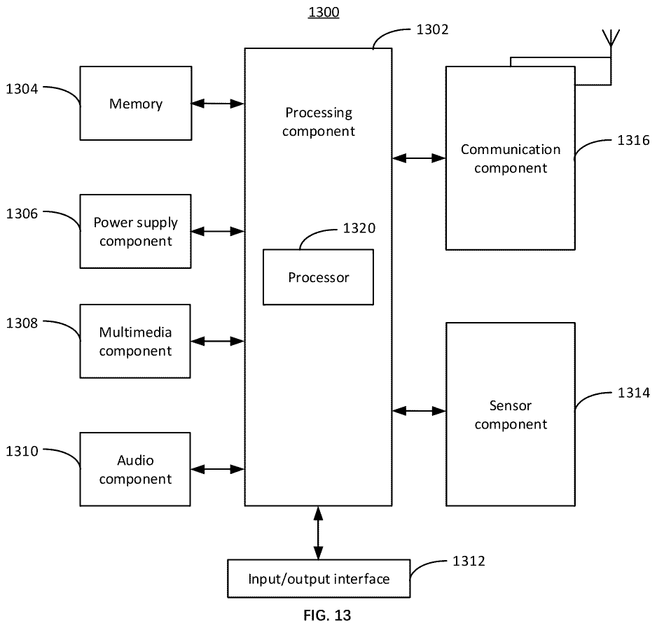

FIG. 13 is a schematic block diagram of a device 1300 for reporting measurement result according to an embodiment of the present disclosure. For example, the device 1300 may be a mobile phone, a computer, a digital broadcast terminal, a messaging device, a game console, a tablet device, a medical device, an exercise device, a personal digital assistant, and the like.

Referring to FIG. 13, the device 1300 may include one or more of the following components: a processing component 1302, a memory 1304, a power supply component 1306, a multimedia component 1308, an audio component 1310, an input/output (I/O) interface 1312, a sensor component 1314, and a communication component 1316.

The processing component 1302 generally controls the overall operation of the device 1300, such as operations associated with display, telephone calls, data communications, camera operations, and recording operations. The processing component 1302 may include one or more processors 1320 to execute instructions to complete all or part of the steps of the method for reporting measurement result described above. In addition, the processing component 1302 may include one or more modules to facilitate interaction between the processing component 1302 and other components. For example, the processing component 1302 may include a multimedia module to facilitate interaction between the multimedia component 1308 and the processing component 1302.

The memory 1304 is configured to store various types of data to support operations at the device 1300. Examples of such data include instructions for any application or method operating on the device 1300, contact data, address book data, messages, pictures, videos, and the like. The memory 1304 may be implemented by any type of volatile or non-volatile storage device or a combination of these devices, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The power supply component 1306 provides power to the various components of the device 1300. The power supply component 1306 may include a power supply management system, one or more power supplies, and other components associated with generating, managing, and distributing power to the device 1300.

The multimedia component 1308 includes a screen that provides an output interface between the device 1300 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding, and a gesture on the touch panel. The touch sensor may not only sense a boundary of a touch action or a slide action, but also detect duration and a pressure related to the touch operation or the slide operation. In some embodiments, the multimedia component 1308 includes a front-facing camera and/or a rear-facing camera. The front-facing camera and/or the rear-facing camera may receive external multimedia data in a case where the device 1300 is in an operating mode, such as a photographing mode or a video mode. Each front-facing camera and rear-facing camera may be a fixed optical lens system that has a focal length and an optical zoom capability.

The audio component 1310 is configured to output and/or input an audio signal. For example, the audio component 1310 may include a microphone (MIC), and the microphone is configured to receive external audio signals when the device 1300 is in an operational mode, such as a call mode, a recording mode, and a voice recognition mode. The received audio signal may further be stored in the memory 1304 or transmitted via the communication component 1316. In some embodiments, the audio component 1310 further includes a speaker configured to output an audio signal.

The I/O interface 1312 provides an interface between the processing component 1302 and a peripheral interface module, where the peripheral interface module may be a keyboard, a click wheel, a button, and the like. These buttons may include, but are not limited to: home button, volume buttons, start button, and lock button.

The sensor component 1314 includes one or more sensors, configured to provide status evaluation in various aspects for the device 1300. For example, the sensor component 1314 can detect the open/closed state of the device 1300, and the relative positioning of components such as a display and keypad of the device 1300. The sensor component 1314 can also detect a change in the position of the device 1300 or a component of the device 1300, the presence or absence of user contact with the device 1300, an orientation or acceleration/deceleration of the device 1300, and a change in the temperature of the device 1300. The sensor component 1314 may include a proximity sensor, configured to detect the presence of a nearby object in the absence of any physical contact. The sensor component 1314 may further include an optical sensor, such as a CMOS or CCD image sensor, configured to be used in an imaging application. In some embodiments, the sensor assembly 1314 may further include an acceleration sensor, a gyroscope sensor, a magnetic sensor, a pressure sensor, or a temperature sensor.

The communication component 1316 is configured to facilitate a wired or wireless communication between the device 1300 and other devices. The device 1300 may access a wireless network based on a communication standard, such as Wi-Fi, 2G, 3G, 4G LTE and 5G NR, or a combination of the Wi-Fi, 2G, 3G, 4G LTE and 5G NR. In an example embodiment, the communication component 1316 receives a broadcast signal or broadcast associated information from an external broadcast management system via a broadcast channel. In an example embodiment, the communication component 1316 further includes a near field communication (NFC) module to facilitate short range communications. For example, the NFC module may be implemented based on radio frequency identification (RFID) technology, infrared data association (IrDA) technology, ultra-wideband (UWB) technology, Bluetooth (BT) technology, and other technologies.

In an example embodiment, the device 1300 may be implemented by one or more application specific integrated circuits (ASICs), digital signal processors (DSPs), digital signal processing devices (DSPDs), programmable logic devices (PLDs), field programmable gate arrays (FPGAs), controllers, micro controller units, microprocessors, or other electronic components, and is configured to perform the method for reporting measurement result described above.

In an example embodiment, further provided is a non-transitory computer-readable storage medium including instructions, such as the memory 1304 including instructions, executable by the processor 1320 of the device 1300 to perform the method for reporting measurement result described above. For example, the non-transitory computer-readable storage medium may be a ROM, a random access memory (RAM), a CD-ROM, a magnetic tape, a floppy disk, an optical data storage device, and the like.

Other embodiments of the present disclosure will be apparent to those skilled in the art based on the specification and practice of the present disclosure disclosed herein. The present disclosure is intended to cover any variations, uses or adaptive changes of the present disclosure that follow the general principles of the present disclosure and comprise common general knowledge and conventional technical means that are within the art to which the present disclosure pertains and are not disclosed in the present disclosure. The specification and embodiments are considered as examples only, with a true scope and spirit of the present disclosure being instructed by the following claims.

It is understood that the present disclosure is not limited to the precise arrangements that have been described above and shown in the drawings, and that various modifications and changes can be made without departing from the scope of the present disclosure. The scope of the present disclosure is limited by the appended claims.

It is noted that, in the present disclosure, relational terms such as “first” and “second” are merely used to distinguish one entity or operation from another entity or operation without necessarily requiring or implying any actual relationship or order between such entities or operations. Terms “include”, “comprise”, or any other variants are intended to cover a non-exclusive inclusion, so that a process, a method, an article, or a device that includes a list of elements includes those elements, and also includes other elements which are not expressly listed, or further includes elements inherent to this process, method, article, or device. An element preceded by “includes a . . . ” does not, without more constraints, preclude the existence of additional identical elements in the process, method, article, or device that includes the element.

The methods and devices provided by embodiments of the present disclosure are described in detail above. The principle and implementation of the present disclosure are described herein by using specific examples. The descriptions about embodiments of the present disclosure are merely provided, to help understand the method and core ideas of the present disclosure. In addition, those of ordinary skill in the art can make variations and modifications to the present disclosure in terms of the specific implementations and application scopes according to the ideas of the present disclosure. Therefore, the content of specification is not construed as a limit to the present disclosure.

1. A method for reporting measurement result, performed by a terminal, wherein the method comprises:
obtaining a measurement result by measuring a signal strength of a cell-specific reference signal (CRS); and
reporting the measurement result to a network device, wherein the measurement result is configured to assist the network device in determining a CRS pattern for the terminal to perform rate matching.

2. The method according to claim 1, wherein obtaining the measurement result by measuring the signal strength of the CRS comprises:
obtaining the measurement result by measuring the signal strength of the CRS within a predetermined resource range.

3. The method according to claim 2, wherein the predetermined resource range comprises a time domain resource range, and within the time domain resource range, signals other than the CRS are not expected to be received, and data transmission is not expected to be performed.

4. The method according to claim 2, wherein measuring the signal strength of the CRS comprises:
determining a to-be-measured CRS pattern according to a signaling of the network device;
determining a resource element (RE) corresponding to the to-be-measured CRS pattern within the predetermined resource range; and
obtaining the measurement result by measuring a signal strength on at least one RE.

5. The method according to claim 4, wherein reporting the measurement result to the network device comprises:
determining a mean value of the signal strength measured on the at least one RE corresponding to the to-be-measured CRS pattern;
determining a relevant identifier of a to-be-measured CRS pattern corresponding to a mean value greater than a preset mean value threshold; and
reporting the relevant identifier to the network device.

6. The method according to claim 2, wherein measuring the signal strength of the CRS comprises:
measuring a signal strength of a received signal in an RE within the predetermined resource range;
determining an RE pattern formed by an RE with a signal strength greater than a preset strength threshold;
determining a matched pattern matching the RE pattern in a pre-stored CRS pattern; and
determining the measurement result according to a signal strength corresponding to an RE in the matched pattern.

7. The method according to claim 6, wherein reporting the measurement result to the network device comprises:
reporting a feature of the matched pattern to the network device.

8. The method according to claim 6, wherein reporting the measurement result to the network device comprises:
determining a mean value of the signal strength measured on at least one RE corresponding to the matched pattern;
determining a target pattern corresponding to a mean value greater than a preset mean value threshold;
determining a cell identifier corresponding to a CRS sequence measured in an RE of the target pattern; and
reporting the cell identifier to the network device.

9. The method according to claim 1, wherein the method further comprises:
determining a CRS pattern needing to be subjected to rate matching according to instruction information transmitted by the network device.

10. A method for receiving measurement result, performed by a network device, wherein the method comprises:
receiving a measurement result obtained by measuring a signal strength of a cell-specific reference signal (CRS) by a terminal, wherein the measurement result is configured to assist in determining a CRS pattern for the terminal to perform rate matching.

11. The method according to claim 10, wherein the method further comprises:
configuring a resource range for the terminal to measure the signal strength of the CRS.

12. The method according to claim 11, wherein the resource range comprises a time domain resource range, and signals other than the CRS or data are not transmitted to the terminal within the time domain resource range.

13. The method according to claim 10, wherein the method further comprises:
instructing a to-be-measured CRS pattern to the terminal through a signaling, wherein the to-be-measured CRS pattern is used for the terminal to determine the measurement result.

14. The method according to claim 10, wherein the method further comprises:
determining a CRS pattern for the terminal to perform rate matching according to the measurement result; and
transmitting instruction information to the terminal, wherein the instruction information is configured to instruct a CRS pattern needing to be subjected to rate matching.

15-16. (canceled)

17. A communication device, comprising:
one or more processors; and
a memory that stores computer programs; wherein
the computer programs, when executed by the one or more processors, causes the one or more processors to:
obtain a measurement result by measuring a signal strength of a cell-specific reference signal (CRS); and
report the measurement result to a network device, wherein the measurement result is configured to assist the network device in determining a CRS pattern for a terminal to perform rate matching.

18. A communication device, comprising:
one or more processor; and
a memory that stores computer programs; wherein
the computer programs, when executed by the one or more processors, causes the one or more processors to implement the method for receiving measurement result according to claim 10.

19. A non-transitory computer-readable storage medium, wherein the computer-readable storage medium stores computer programs configured to be executed by one or more processors of a processing device, the one or more programs comprising instructions, and the instructions, when executed by the processing device, causes the processing device to implement the method for reporting measurement result according to claim 1.

20. A non-transitory computer-readable storage medium, wherein the computer-readable storage medium stores computer programs configured to be executed by one or more processors of a processing device, the one or more programs comprising instructions, and the instructions, when executed by the processing device, causes the processing device to implement the method for receiving measurement result according to claim 10.

21. The communication device according to claim 17, wherein the one or more processors are collectively configured to:
obtain the measurement result by measuring the signal strength of the CRS within a predetermined resource range.

22. The communication device according to claim 21, wherein the predetermined resource range comprises a time domain resource range, and within the time domain resource range, signals other than the CRS are not expected to be received, and data transmission is not expected to be performed.
